(19) United States
(12) Patent Application Publication
(10) Pub. No.: US 2017/0151773 A1
(43) Pub. Date: Jun. 1, 2017

(54) SYSTEM FOR PRINTING ON BALLOONS

(71) Applicant: Aamer Shams, Hansworth (GB)

(72) Inventor: Aamer Shams, Hansworth (GB)

(21) Appl. No.: 15/427,788

(22) Filed: Feb. 8, 2017

Related U.S. Application Data
(63) Continuation of application No. 14/056,193, filed on Oct. 17, 2013, now abandoned.

(30) Foreign Application Priority Data
Oct. 17, 2012 (GB) 1218679.7

(51) Int. Cl. B41F 17/00; A63H 27/10; B41M 1/10; B41M 1/12; B41M 1/04

(52) U.S. Cl. CPC B41F 17/00; B41M 1/12; B41M 1/04; B41M 1/10; A63H 27/10; A63H 2027/1025

(57) ABSTRACT

The present invention provides a system for printing on balloons where the priming of the balloons to receive print is substantially free of bubbles, the system comprising locally applying to a balloon external surface or to a balloon precursor sheet in a defined, limited area one of: a) a pre-shaped self adhesive label comprising a layer of primer that is adhesive-backed; b) a coating of primer that will be formed into the external surface area of a balloon wherein the remaining external surface area of the balloon is coated with a primer repellent material; c) a coating of primer by a silk screen process wherein the applied primer is subjected to a partial vacuum to draw air out from the coating and/or is subjected to the action of a roller or scraper that is held or pressed lightly against the coating to squeeze air from the coating.

### CROSS REFERENCE TO RELATED APPLICATIONS

This application is a continuation of U.S. patent application Ser. No. 14/056,193 entitled System For Printing on Balloons, filed on Oct. 17, 2013 and currently pending, which claims the benefit of GB1218679.7, entitled System for Printing on Balloons, filed on Oct. 17, 2012 and currently pending; the entirety of which is incorporated herein by reference.

### FIELD OF THE INVENTION

The present invention concerns improvements in and relating to systems for fine printing on balloons where the print is applied to a print substrate area on the balloon. The balloons in question are generally of the substantially non-expanding (not resiliently expandible) type such as of foil, PVC or Mylar rather than the more traditional latex/elastomeric balloons.

### BACKGROUND TO THE INVENTION

Foil balloons for parties or other special occasions or for marketing or simply for fun are nowadays often decorated with graphic images and lettering. They may for example, spell out greetings messages or carry images of cartoon characters or even a favourite photograph.

When it is desired to print onto the surface of a balloon with graphic images or lettering/numbers or other characters the print is usually applied to the balloon by screen printing or, more cheaply but less effectively, litho (offset) printing. The normal preparation of the balloon's surface to receive and hold the print involves applying an ink-receptive/ink-absorbing primer onto the balloon to provide the substrate onto which the print is then applied. This ink-absorbing primer material is commonly referred to in the art as ‘glue’ but herein will be referred to as primer. The primer is normally coated over the whole external surface of the balloon by bathing the balloon in the primer or by forming the balloon material as a laminate with primer universally covering one side. However, these approaches tend to have a deleterious effect on buoyancy of the balloon.

A preferable approach is to apply the primer in a finite region/zone of the balloon that suitably covers substantially less than half of the balloon surface (ie substantially less than all of one face of the flat, un-inflated balloon). This is however not straightforward to do neatly. We have found that use of known screen printing techniques to apply primer in a defined area to a balloon does not lead to a smooth, clean finish to that area of the balloon but rather is liable to formation of myriad small bubbles in that area spoiling the appearance and potentially disrupting the neat printing of the graphics or lettering/numbering on that area, Where, for example, the print comprises graphics such as photographic images and involves registration of multiple different colours the surface imperfections can substantially impair the precision quality of the finished appearance. For the part of the balloon where precision/fine printing is desired a solution is needed

### SUMMARY OF THE INVENTION

According to the present invention there is provided a system for printing on balloons where the priming of the balloons to receive print is substantially free of bubbles, the system comprising locally applying to a balloon external surface or to a balloon precursor sheet from which a balloon is to be made in a defined, limited area of the balloon or of the balloon precursor sheet area that will be formed into a balloon one of: a) a pre-shaped self adhesive label comprising a layer of primer that is adhesive-backed; b) a coating of primer in a defined limited area of the external surface of the balloon or of the balloon precursor sheet area that will be formed into the external surface area of a balloon wherein the remaining external surface area of the balloon at least on one side of the balloon is coated with a primer repellent material; e) a coating of primer by a silk screen process wherein the applied primer is subjected to a partial vacuum in a vacuum chamber to draw air out from the coating and/or is subjected to the action of a roller or a scraper that is held against or pressed lightly against the coating before the primer coating sets to drive bubbles from the primer surface.

As used herein the term balloon precursor refers to a sheet of the material from which a balloon is to be formed, whether that be of foil, PVC, Mylar or any other material, laminate or not. The sheet for a balloon assembly line may be supplied as a roll or might be stacked as a concertina. The sheet may normally be many tens or hundreds of metres in length but normally substantially less than a metre wide and allows for a series of balloons to be laser or die cut. punched or otherwise formed from it.

Accordingly the present invention allows for the steps of the system to be operated on one or more un-inflated but otherwise fully formed balloons or else on one or more continuous or discontinuous sheet(s) from which one or more balloons are to be formed prior to the stage at which the balloons are formed.

In b) the coating of primer is applied in a defined limited area of the external surface of the balloon, the remaining external surface area of the balloon that is intended to be free of primer is coated with a primer repellent material. Suitably the primer repellent material is hydrophobic being an oil/oil-based material since primers are generally water-based. The defined limited wettable area may simply comprise an area of the balloon surface that is free of the oily/non-wettable coating ie is the uncoated balloon surface or preferably it may have a more hydrophilic material/wettable material applied to the balloon surface there.

Preferably the primer repellent material is coated/painted onto the not-to-be-primed area of the balloon surface by a brush, roller or pad in such a way that the area to be primed is not coated with it. The primer repellent material may be coated on the not-to-be-primed area of the balloon surface by silk screen printing, flexo-printing or gravure printing. The use of silk screen printing for this does not affect the image or text printing to be applied to the balloon since it is not where the printing is applied. Furthermore, if desired the primer repellent material may be washed/dissolved away from the balloon after the primer has been applied, suitably by an organic solvent such as, for example, acetone.

The step of applying the primer may be done using a bath of primer or unilaterally using a pad, roller or other coating appliance that applies it over the side (normally the upper face as the balloon moves along the production line) of the balloon that is to be printed. The primer simply does not bond to the area of that face where the primer repellent material is applied and that area remains primer free. In a variant of this, if there is some excess primer loosely overlying the primer repellent material the excess primer may be removed in a washing step that leaves the primer only in the area that is free of the primer repellent material.

Preferably in a) the self adhesive label that is adhered to the balloon comprises solely the primer layer with the adhesive thereon. Ideally this label will generally be very thin—often of the order of 10 to 20 microns microns or less. However, one or more additional material layers may be provided between the primer layer and the adhesive layer if required. Preferably a peelable quick release cover sheet, such as a silicone release paper, is provided that covers the adhesive layer prior to applying the label. A peelable cover sheet is suitably also provided as a cover/backing to the outer face of the primer layer prior to applying the label.

Suitably the self adhesive labels are handled in an automated assembly line by use of ‘sticky strings’, being low tack adhesive coated strips/lengths of flexible material whereby the strips/lengths can be used to pick up and carry the labels in a series and deposit each label onto a successive one of a series of balloons on the assembly line as the strips/lengths are peeled away at an angle to the plane of the balloons that are travelling flat along the production line.

The self adhesive labels are preferably manufactured by laminating a layer of ink-receptive primer with a layer of an adhesive that will securely/non-releasably bond to the balloon surface, suitably by coating one layer with the other. The peelable cover sheets are suitably applied on the outer face of the adhesive layer and of the primer layer respectively. The assembled laminate is suitably as an elongate strip that extends longitudinally of a label production line and the shape of the individual labels is punched/cut in the strip at intervals along the strip. The label shape is suitably punched/cut through all except the peelable cover sheet that covers the adhesive layer. The latter is suitably left in place until the final label applying step, suitably only being peeled away from the labels in use at a balloon label-applying production line station where each label is finally readied to be applied onto its respective balloon. Here the labels are suitably carried forward to the balloons by the ‘sticky strings’ as the labels are separated from the cover sheet strip exposing the mounting adhesive to stick the label onto its balloon and the strings are peeled way to leave each label in its place mounted onto a respective balloon.

In c) when a coating of primer is applied to the balloon by a silk screen process and the applied primer is subjected to a partial vacuum, preferably this is done in a vacuum chamber of a production line. The vacuum chamber suitably encases a section of the production line. The partial vacuum applied is preferably to reduce the air pressure to ⅔ atmospheric or less. A pressure of about ⅓ atmosphere is preferred.

Preferably the primer is subjected to hot air drying after the vacuum treatment, but preferably after a few minutes have elapsed to allow the primer to settle, removing craters from any bubbles that have burst at the surface.

Hot air drying is suitably conducted by passing the balloons/balloon precursors through a hot air tunnel/dryer that preferably dries the primer slowly as it passes through the hot air tunnel. Such tunnel might suitably be of the order of 80 m in length to retain the heated air at say 30-40° C. over the balloons for a suitable period of the order of a few minutes, eg 2 to 4 minutes. This concluding air drying step may be applied to each of the afore-mentioned approaches a), b) and c).

In c) when a coating of primer is applied to the balloon by a silk screen process and the applied primer is subjected to the action of a roller or scraper, this roller or scraper is suitably provided mounted on a support (eg on an overhead gantry) of a corresponding production line, Where the applied primer is applied by a scraper this suitably is a bar or might be a long straight edge of a structure.

Where the applied primer is subjected to the action of a roller that is pressed lightly against the coating to roll and squeeze air from the coating this is preferably done with the roller being resiliently biased/sprung towards the balloons that are being carried on a production line. Preferably the pressing roller is rotated at substantially the same rate of rotation as the nearest transport rollers of the production line and the balloons remain unruffled by the pressing roller. The pressing roller is preferably located parallel to and substantially directly vertically above the nearest transport roller of the production line and counter-rotates relative to that nearest transport roller.

In any of the afore-mentioned approaches a), b) and c) the balloon or balloon precursor may be pre-printed with background print using any of various printing techniques including, for example, the traditional silk screen printing method. The background printed images might simply be repeated patterning such as hearts or stars and their quality does not need to be controlled by the measures of the present invention even if silk screening is used for the background printing. In the case of approach b) the background printing, if any, is suitably applied using oil based printing and suitably is sealed prior to or when applying the primer repellant layer.

The system may be embodied as a method of manufacturing printed balloons or as production apparatus for manufacturing printed balloons adapted/configured and/or programmed to carry out the method steps outlined.

### BRIEF DESCRIPTION OF THE DRAWINGS

The various preferred embodiments of the present invention will now be further described, by way of example only, with reference to the accompanying drawings, in which:

FIG. 1 is a side elevation view of a laminated assemblage of shaped primer label as manufactured prior to exposing the adhesive for applying to a balloon as in the first preferred embodiment ; and

FIG. 2 is a plan view from above of a production line for manufacture of the labels;

FIG. 3 is a side elevation view of production line for applying the labels to balloons.

FIG. 4 is a side elevation view of part of a production line of a second embodiment post applying the primer coating on the balloon or balloon precursor by silk screen, comprising a roller for squeezing bubbles from the primer coating prior to drying the primer.

FIG. 5 is a plan view of part of a face of a balloon or balloon precursor of a third embodiment wherein the primer coating on the balloon or balloon precursor is framed by a primer repellant that is first applied to the balloon or balloon precursor before the primer is applied and thereby delimits where the primer can adhere to the balloon or balloon precursor.

### DESCRIPTION OF THE PREFERRED EMBODIMENTS

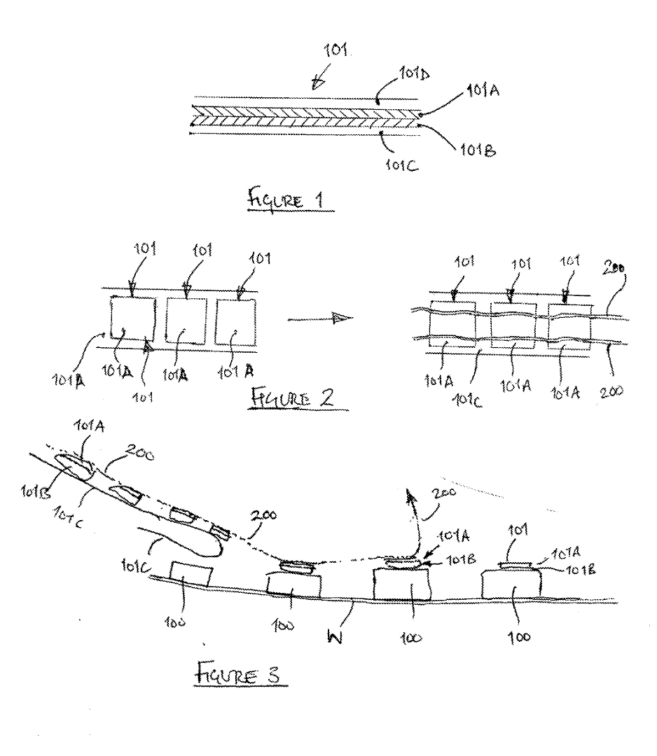

In the first preferred embodiment of the invention illustrated by FIGS. 1, 2 and 3, the primer is applied to each balloon or balloon precursor 100 on a production line with the primer having the form of a self adhesive label 101 that is adhered to the balloon or balloon precursor 100.

Each self adhesive label 101 comprises the primer layer 101A with the adhesive layer 101B laminated to it/coated on it. This label will generally be of the order of 10 to 20 microns or less in thickness. One or more additional material layers may be provided between the primer layer 101A and the adhesive layer 101B if required. A peelable quick release cover sheet 101C, such as a silicone release paper, is provided that covers the adhesive layer 101B prior to applying the label 101. A peelable cover sheet 101D is suitably also provided as a cover/backing to the outer face of the primer layer 101A prior to applying the label 101.

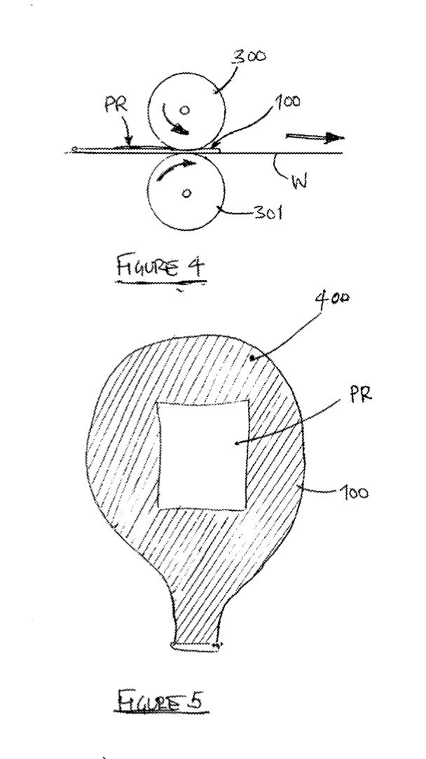

As illustrated in FIGS. 2 and 3, the self adhesive labels 101 are initially formed in a series on a common long sheet 103. They are stamped out/delimited by punching through the top three layers, peelable cover sheet 101D, primer layer 101A and adhesive layer 101B so that the peelable cover sheet 101D part surrounding/framing the labels 101 can be then be pulled to remove cover sheet 101D collectively by peeling away, leaving the labels 101 isolated from each other as seen from the top view, left hand end of FIG. 2 but still carried together by their other cover sheet 101C.

The primer ‘labels’ 101 are then carried farther along the label production line whereupon, as shown at the right hand end of FIG. 2, at least one, but preferably at least two ‘sticky strings’ 200 are lowered onto the series of labels 101. These ‘sticky strings’ 200 are low tack adhesive coated strips/lengths of flexible material whereby the strips/lengths 200 can be used to pick up and carry the labels 101 in a series while the peelable cover sheet 101C covering the adhesive layer 101B is pulled away as illustrated at the left hand end of FIG. 3. This then deposits each label 101 onto a successive one of a series of balloons or balloon precursors 100 on the conveyor web W of the assembly line. The label 101 is deposited on the balloon or balloon precursor 100 as the sticky string strips/lengths 200 are peeled away at an angle to the plane of the balloons 100 that are travelling flat along the transport web/conveyor W of the production line.

The successive individual labels 101 are suitably separated by a gap or at least by a line of perforations/micro-perforations.

In a preferred sequence of operation of the FIG. 1, 2 embodiment the balloon is preferably first printed with a background design (if any), suitably by flexo-printing. The balloon preferably is then formed into a blank suitable for fine printing on by a printer, by folding around a support substrate carrier such as of card and being held in place thereon by adhesive/tape. A tab is suitably attached to one or both ends of the balloon blank to aid feeding through the printer. The adhesive-backed primer film label 101 is applied to the balloon blank and the balloon blank is then ready for fine printing on in a printer.

Turning to FIG. 4, this illustrates an embodiment of the invention in which the coating of primer PR is first applied in a defined limited area of one side of the external surface of the balloon or balloon precursor 100 by silk screen printing. Then in the step illustrated in FIG. 4 the balloon or balloon precursor 100 is treated by a roller 300 that rolls over the balloons applied primer coating PR to squeeze air from the coating. The roller 300 may be lightly resiliently biased/sprung towards the balloons 100 that are being carried on the production line and the roller 300 is suitably the same diameter as and rotated at substantially the same rate of rotation as the nearest transport rollers of the production line. The balloons 100 remain unruffled by the pressing roller 300 as they pass thereunder. The roller 200 simply drives bubbles, or at least surface bubbles, from the primer coating PR without damaging the coating PR. The pressing roller 300 is here shown as located parallel to and substantially directly vertically above the nearest transport roller 301 of the production line and counter-rotates relative to that nearest transport roller 301. The roller 300 may be mounted/configured to impinge into/press into only the upper part (upper ⅓ to ⅔) of the primer coating PR to successfully remove the surface bubbles.

In a preferred sequence of operation of the FIG. 4 embodiment the balloon is preferably first printed with a background design (if any), suitably by flexo-printing. The balloon preferably is then formed into a blank suitable for printing on by a printer, by folding around a support substrate carrier such as of card and being held in place thereon by adhesive/tape. A tab is suitably attached to one or both ends of the balloon blank to aid feeding through the printer. This balloon blank forming and printing process is detailed in the present applicant's U.S. patent application Ser. No. 13/924,564 (originally published as PCT/GB2011/001751, the contents of which are incorporated herein by reference). Next the primer is applied to the balloon (preferably by screen printing) and then, directly after the primer is applied the balloon is run below the pressing roller 300 or between pairs of opposing rollers before the primer sets to pop any forming air bubbles. A second pressing roller or pair of co-acting rollers may be positioned downstream of the first roller or set of rollers. The pressing roller in FIG. 4 may be replaced by a scraper bar, but use of one or more rollers is nevertheless preferable.

Turning to FIG. 5. this illustrates an embodiment of the invention in which the coating of primer PR is applied in a defined limited area of the external surface of the balloon, the remaining external surface area of the balloon that is intended to be free of primer being coated with a primer repellent material 400. The primer repellent material 400 is hydrophobic being an oil/oil-based material to suit use to repel the primers that are generally water-based. The defined limited ‘wettable’ area may simply comprise an area of the balloon surface that is free of the oily/non-wettable coating 400 ie is the uncoated balloon surface or preferably it has a coating of a more hydrophilic material/wettable material applied to the balloon surface there. The primer repellent material 400 is coated/painted onto the not-to-be-primed area of the balloon surface by a brush, roller or pad in such a way that the area to be primed is not coated with it. The primer repellent material may be coated on the not-to-be-primed area of the balloon surface (hatched area shown in FIG. 5) by silk screen printing, flexo-printing or gravure printing. The step of applying the primer may be done using a bath of primer or unilaterally using a pad, roller or other coating appliance that applies it over the side (normally the upper face as the balloon moves along the production line) of the balloon 100 that is to be printed.

In a preferred sequence of operation of the FIG. 5 embodiment the balloon is preferably first printed with a background design (if any), suitably by flexo-printing. Next the primer repellent material is applied to the balloon framing the area that is to be primed and printed. The primer is then applied and dried, suitably by using the rollers or scraper bar or by passing through a vacuum chamber before the primer sets. Finally the balloon preferably is then formed into a blank suitable for fine printing on by a printer, by folding around a support substrate carrier such as of card and being held in place thereon by adhesive/tape. A tab is suitably attached to one or both ends of the balloon blank to aid feeding through the printer.

In a further embodiment of the invention a coating of primer is applied to the balloon by a silk screen process and the applied primer is then subjected to a partial vacuum in a vacuum chamber of a production line. The vacuum treatment suitably lasts for of the order of 30 seconds or more. The vacuum chamber suitably encases a section of the production line and the partial vacuum applied is about ⅓ atmosphere. The primer is subjected to hot air drying after the vacuum treatment, but after a few minutes have elapsed to allow the primer to settle, removing craters from any bubbles that have burst at the surface. The balloons/balloon precursors are subjected to hot air drying by passing through a hot air tunnel/dryer that dries the primer slowly as it passes through the hot air tunnel. Such tunnel can be of the order of 80 m in length to retain the heated air at say 30-40° C. over the balloons for a suitable period of the order of a few minutes, eg 2 to 4 minutes.

As with all of the other embodiments, in the sequence of operation preferably a background print (if any) is applied initially (suitably by flexo-printing) before the localised finer print is applied. As a next step after applying the background print the balloon is suitably assembled as a balloon blank for being printed on in a printer, by being mounted to a support substrate/carrier card for passing through the printer and being held in that folded state by adhesive. The support suitably has a feeding tab at at least one end for facilitating feeding through the printer. Primer is suitably then applied to the balloon, preferably by screen printing and the balloon is placed in or carried through a vacuum chamber at the required partial vacuum and for the required time and subsequently heated or otherwise allowed to dry before further handling.

What is claimed is:

1. A system for printing on balloons where the priming of the balloons to receive print is substantially free of bubbles, the system comprising locally applying to a balloon external surface or to a balloon precursor sheet, from which a balloon is to be made, in a defined, limited area of said balloon or of said balloon precursor sheet that will be formed into a balloon one of:
a) a pre-shaped self adhesive label comprising a layer of primer that is adhesive-backed;
b) a coating of primer in a defined limited area of said balloon external surface or of said balloon precursor sheet that will be formed into an external surface area of a balloon, wherein a remaining external surface area of the balloon, at least on one side of the balloon, is coated with a primer repellent material;
c) a coating of primer by a silk screen process wherein said primer is subjected to a partial vacuum in a vacuum chamber to draw air or other gas out from said coating of primer and/or is subjected to the action of a roller or a scraper that is held against or pressed against said coating of primer before said coating of primer sets to drive bubbles from a surface of said coating of primer.

2. The system as claimed in claim 1, wherein in a) the pre-shaped self adhesive label, when adhered to the balloon, comprises solely the primer layer with the adhesive thereon.

3. The system as claimed in claim 1, wherein in a) the pre-shaped self adhesive label, when adhered to the balloon, comprises the primer layer and the adhesive layer and one or more intermediate layers.

4. The system as claimed in claim 1, wherein in b) the primer repellent material is hydrophobic comprising an oil or an oil-based material and the defined limited area simply comprises an area of the balloon or balloon precursor surface that is free of the primer repellent material.

5. The system as claimed in claim 1, wherein in b) the primer repellent material is hydrophobic comprising an oil or an oil-based material when the primer is water-based.

6. The system as claimed in claim 5, wherein the defined limited area has a hydrophilic material comprising a wettable material applied to the balloon surface.

7. The system as claimed in claim 5, wherein the primer repellent material is coated by a brush, roller or pad in such a way that the defined, limited area is not coated with said primer repellent.

8. The system as claimed in claim 5, wherein the primer repellent material is coated by silk screen printing, flexo-printing or gravure printing.

9. The system as claimed in claim 5, wherein the primer is coated using a bath of primer or unilaterally using a pad, roller or other coating appliance that applies it over the side of the balloon that is to be printed.

10. The system as claimed in claim 1, wherein in a) the self adhesive label comprises the primer layer with the adhesive thereon and a peelable quick release cover sheet, such as a silicone release paper, wherein said peelable quick release cover sheet covers said adhesive prior to applying said self adhesive label.

11. The system as claimed in claim 10, wherein a peelable cover sheet is provided as a cover/backing to an outer face of the primer prior to applying the label.

12. The system as claimed in claim 11, wherein the self adhesive labels are manufactured by laminating a layer of an ink-receptive primer with a layer of an adhesive that will securely/non-releasably bond to the balloon surface and the peelable cover sheets are applied on an outer face of the adhesive layer and of the primer layer respectively.

13. The system as claimed in claim 11, wherein self adhesive labels are formed in an elongated strip that extends longitudinally off a label production line and the shape of the individual labels is punched/cut in the strip at intervals along the strip.

14. The system as claimed in claim 1, wherein in a) the self adhesive labels are handled in an automated assembly line by use of ‘sticky strings’, being a low tack adhesive coated strips/lengths of a flexible material whereby said low tack adhesive coated strips/lengths can be used to pick up and carry the labels in a series and deposit each label onto a successive one of a series of balloons or balloon precursors on said assembly line as said low tack adhesive coated strips/lengths are peeled away at an angle to a plane of said balloons or said balloon precursors that are travelling flat along the production line.

15. The system as claimed in claim 1, wherein in c) when a coating of primer is applied to the balloon by a silk screen process and the applied primer is subjected to a partial vacuum this is done in a vacuum chamber of a production line that encases a section of said production line.

16. The system as claimed in claim 1, wherein in c) the partial vacuum applied is ⅔ atmospheric pressure or less.

17. The system as claimed in claim 1, wherein in c) the primer is subjected to hot air drying after said primer is subjected to a partial vacuum once a few minutes have elapsed to allow said primer to settle, thereby removing craters from any bubbles that have burst at the surface.

18. The system as claimed in claim 1, wherein the primer is subjected to hot air drying by passing the balloons/balloon precursors through a hot air tunnel/dryer.

19. The system as claimed in claim 1, wherein in c) when a coating of primer is applied to the balloon by a silk screen process and the applied primer is subjected to the action of a roller or a scraper edge that is held or pressed against the coating to drivel squeeze air from the coating surface this is done with the balloons or balloon precursors being carried forwards on a production line, the roller or a scraper edge extending transverse to the production line at a stage along the production line and the forward travel of the balloons or balloon precursors on the production line causing the roller or scraper edge to sweep over the primer coating on each balloon to purge bubbles from the primer coating surface.

20. The system as claimed in claim 19, wherein the roller is rotated at substantially the same rate of rotation as a nearest transport roller of the production line.

21. The system as claimed in claim 19, wherein the roller is located parallel to and substantially directly vertically above a nearest transport roller of the production line and counter-rotates relative to said nearest transport roller.

22. The system as claimed in claim 1, wherein in c) the roller or scraper is resiliently biased/sprung to press against the balloons or balloon precursors.

23. The system as claimed in claim 1 wherein the balloon or balloon precursor is preprinted with background print around the defined, limited area of the balloon before or after the primer is applied.

24. The system as claimed in claim 23, wherein the background print around the defined, limited area of the balloon is applied before the primer is applied and is sealed before or when the primer repellant coating is applied.

25. A system for printing on balloons, the system comprising locally applying to a balloon external surface or to a balloon precursor sheet, from which a balloon is to be made, in a defined, limited area of the balloon or of the balloon precursor sheet area that will be formed into a balloon, a coating of primer in a defined limited area of the external surface of the balloon or of the balloon precursor sheet area that will be formed into the external surface area of a balloon, wherein a remaining external surface area of the balloon, at least on one side of the balloon, is coated with a primer repellent material.

26. A balloon or a balloon precursor sheet from which a balloon is to be made, having locally applied to the balloon external surface or in a defined, limited area of the balloon or of the balloon precursor sheet area that will be formed into a balloon one of:
a) a pre-shaped self adhesive label comprising a layer of primer that is adhesive-backed;
b) a coating of primer in a defined limited area of the external surface of the balloon or of the balloon precursor sheet area that will be formed into the external surface area of a balloon wherein a remaining external surface area of the balloon, at least on one side of the balloon, is coated with a primer repellent material;
c) a coating of primer by a silk screen process wherein the applied primer is subjected to a partial vacuum in a vacuum chamber to draw air or other gas out from the coating and/or is subjected to the action of a roller or a scraper that is held against or pressed against said coating of primer before said coating of primer sets to drive bubbles from a surface of said coating primer.
